(19) United States
(12) Patent Application Publication
(10) Pub. No.: US 2023/0197978 A1
(43) Pub. Date: Jun. 22, 2023

(54) FUEL CELL COMPONENT INCLUDING POLYTETRAFLUOROETHYLENE FILM BONDED TO GRAPHITE

(71) Applicant: DOOSAN FUEL CELL AMERICA, INC., South Windsor, CT (US)

(72) Inventors: Benjamin SILVERMAN, South Windsor, CT (US); Timothy William PATTERSON, West Hartford, CT (US); Eric LIVIACH, South Windsor, CT (US)

(21) Appl. No.: 17/552,634

(22) Filed: Dec. 16, 2021

(51) Int. Cl. H01M 8/0245; H01M 8/0234

(52) U.S. Cl. CPC H01M 8/0245; H01M 8/0234

(57) ABSTRACT

An illustrative example embodiment of a fuel cell component includes a graphite substrate, a polytetrafluoroethylene (PTFE) layer adjacent a portion of the graphite substrate, and a plurality of segments of acrylic adhesive between the portion of the graphite substrate and the PTFE layer. The acrylic adhesive secures the PTFE layer to the portion of the graphite substrate. There is spacing between adjacent ones of the segments.

### BACKGROUND

Fuel cells generate electricity based on an electrochemical reaction between reactants such as hydrogen and oxygen. Fuel cell devices include a number of fuel cells in a cell stack assembly. One issue associated with liquid electrolyte fuel cells is managing the electrolyte, such as phosphoric acid, within the cell stack assembly. Achieving desired performance and life of the cell stack assembly requires maintaining adequate electrolyte throughout the stack and preventing acid migration from one cell to the next cell in the stack.

One approach for preventing electrolyte migration is to include fluid-impervious barriers or seals along edges of at least some of the fuel cell components, such as flow field plates. Different methodologies have been proposed for establishing such seals. Even when such seals are effective, the challenge of reducing the cost of fuel cells remains. Approaches that include additional manufacturing steps or that introduce additional time into the assembly process contribute to increased cost and are, therefore, less than ideal.

### SUMMARY

An illustrative example embodiment of a fuel cell component includes a graphite substrate, a polytetrafluoroethylene (PTFE) layer adjacent a portion of the graphite substrate, and a plurality of segments of acrylic adhesive between the portion of the graphite substrate and the PTFE layer. The acrylic adhesive secures the PTFE layer to the portion of the graphite substrate. There is spacing between adjacent ones of the segments.

In an example embodiment having one or more features of the fuel cell component of the previous paragraph, a first edge of the PTFE layer faces toward an adjacent surface on the graphite substrate, a second edge of the PTFE layer faces in an opposite direction than the first edge, an edge of the graphite substrate is spaced from the first edge of the PTFE layer, and the spacing between adjacent ones of the segments prevents the acrylic adhesive from establishing a continuous electrolyte migration path between the first edge of the PTFE layer and the edge of the graphite substrate.

In an example embodiment having one or more features of the fuel cell component of any of the previous paragraphs, the edge of the graphite substrate is adjacent the second edge of the PTFE layer and the spacing between adjacent ones of the segments prevents the acrylic adhesive from establishing a continuous electrolyte migration path between the first edge of the PTFE layer and the second edge of the PTFE layer.

In an example embodiment having one or more features of the fuel cell component of any of the previous paragraphs, the plurality of segments are arranged in a repeating pattern.

In an example embodiment having one or more features of the fuel cell component of any of the previous paragraphs, the plurality of segments are at least partially linear or at least partially round.

In an example embodiment having one or more features of the fuel cell component of any of the previous paragraphs, the plurality of segments are arranged on the PTFE layer.

In an example embodiment having one or more features of the fuel cell component of any of the previous paragraphs, the component is a flow field plate.

In an example embodiment having one or more features of the fuel cell component of any of the previous paragraphs, the graphite substrate includes a plurality of flow channels configured to direct flow in at least one primary direction, and the portion of the graphite substrate comprises a land along an edge of the graphite substrate that is parallel to the at least one primary direction.

In an example embodiment having one or more features of the fuel cell component of any of the previous paragraphs, the portion of the graphite substrate includes at least one edge of the graphite substrate, and the PTFE layer includes a portion that extends beyond the at least one edge.

An example embodiment having one or more features of the fuel cell component of any of the previous paragraphs includes a layer of a fluoroelastomer between the portion of the graphite substrate and the PTFE layer.

An illustrative example embodiment of method of making a fuel cell component includes situating a polytetrafluoroethylene (PTFE) layer adjacent a portion of a graphite substrate with a plurality of segments of acrylic adhesive between the portion of the graphite substrate and the PTFE layer. There is spacing between adjacent ones of the segments. The method includes securing the PTFE layer to the portion of the graphite substrate using the plurality of segments of acrylic adhesive.

In an example embodiment having one or more features of the method of any the previous paragraph, a first edge of the PTFE layer faces toward an adjacent surface on the graphite substrate, a second edge of the PTFE layer faces in an opposite direction than the first edge, the second edge of the PTFE layer is adjacent an edge of the graphite substrate, and the method includes establishing the spacing between adjacent ones of the segments to prevent the acrylic adhesive from establishing a continuous electrolyte migration path between the first edge of the PTFE layer and the second edge of the PTFE layer.

In an example embodiment having one or more features of method of any of the previous paragraphs, the plurality of segments are arranged in a repeating pattern.

In an example embodiment having one or more features of method of any of the previous paragraphs, the plurality of segments are round.

In an example embodiment having one or more features of method of any of the previous paragraphs, the plurality of segments are at least partially linear.

An example embodiment having one or more features of method of any of the previous paragraphs includes applying the plurality of segments to the PTFE layer.

In an example embodiment having one or more features of method of any of the previous paragraphs, the fuel cell component is a flow field plate, the graphite substrate includes a plurality of flow channels configured to direct flow in at least one primary direction, and the portion of the graphite substrate comprises a land along an edge of the graphite substrate that is parallel to the at least one primary direction.

In an example embodiment having one or more features of method of any of the previous paragraphs, the portion of the graphite substrate includes at least one edge of the graphite substrate, and the PTFE layer includes a portion that extends beyond the at least one edge.

An example embodiment having one or more features of method of any of the previous paragraphs includes applying a fluoroelastomer to the portion of the graphite substrate prior to situating the PTFE layer adjacent the portion.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 diagrammatically illustrates a selected portion of an example cell stack assembly including fuel cell components designed according to an example embodiment.

FIG. 2 diagrammatically illustrates a selected portion of another example cell stack assembly including fuel cell components designed according to another example embodiment.

FIG. 3 is a planar view schematically showing one side of an example embodiment of a fuel cell component.

FIG. 4 is planar view schematically showing one side of a layer including segments of an adhesive on the one side.

FIG. 5 schematically illustrates an example configuration of adhesive segments.

FIG. 6 schematically illustrates another example configuration of adhesive segments.

### DETAILED DESCRIPTION

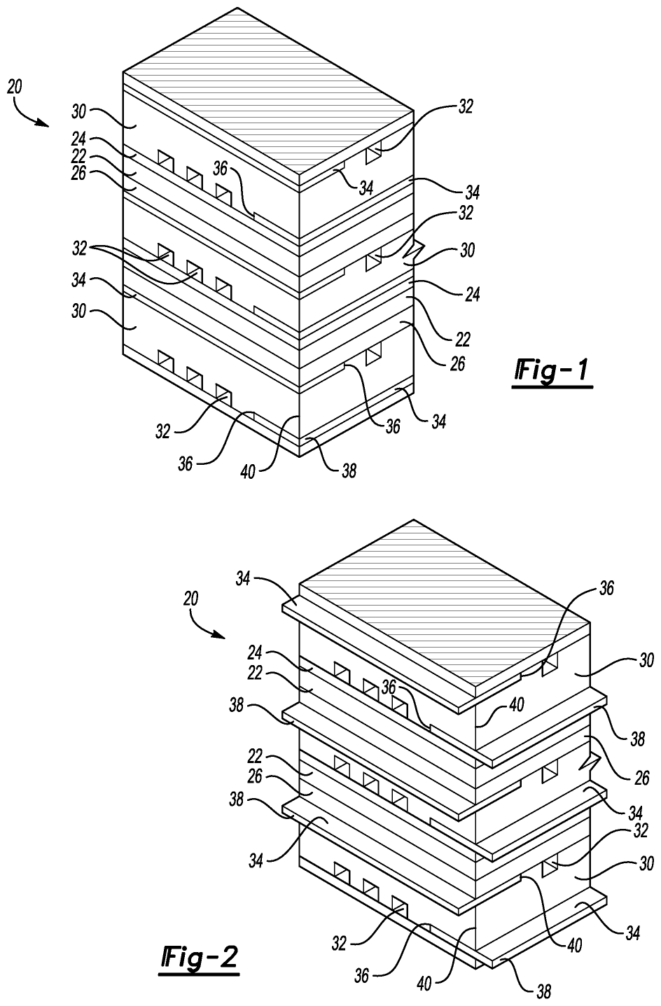

FIG. 1 diagrammatically illustrates selected portions of a cell stack assembly 20 including a plurality of fuel cells. Each fuel cell includes multiple fuel cell components. An electrolyte membrane 22 is situated between electrodes 24, 26. In some embodiments, the electrolyte membrane 22 includes a matrix containing a liquid electrolyte, such as phosphoric acid. Flow field plates 30 comprise graphite and include flow field channels 32 for distributing a reactant fluid, such as hydrogen or oxygen, to the adjacent electrodes 24, 26. In the illustrated example, the flow field plates 30 are part of a separator plate assembly that includes flow field channels 32 on opposite sides. Other embodiments include flow field plates and separator plates that are distinct components.

A hydrophobic layer 34, which comprises polytetrafluoroethylene (PTFE) in this embodiment, is included along at least some of the edges of the flow field plates 30. The PTFE layers 34 are adhesively secured to the graphite substrate of the flow fields 30 by an acrylic adhesive situated between the PTFE layer 34 and the graphite substrate.

In the example embodiment shown in FIG. 1, the PTFE layers 34 provide a seal along the corresponding edges of the flow field plates 30. The PTFE layers 34 include a first edge 36 that faces toward and is received against an adjacent surface of the graphite substrate of the flow field plate 30. A second edge 38 of each PTFE layer 34 is spaced from the first edge 36. In FIG. 1, the second edges 38 are aligned with corresponding edges 40 of the flow field plates 30.

Another example cell stack assembly 20 is shown in FIG. 2. In this example, the PTFE layers 34 extend beyond edges of the flow field plates 30. The second edges 38 of the PTFE layers are laterally outward of the edges 40 of the flow field plates 30. The edges 40 are aligned with the outside edges of the electrodes 24, 26. The protruding or extending portions of the PTFE layers 34 serve as barriers to liquid electrolyte (e.g., phosphoric acid) migration between and among the cells in the cell stack assembly 20.

In FIGS. 1 and 2, the PTFE layers 34 are at least partially received in a recess or land along the corresponding edges 40 of the graphite substrate of the corresponding flow field plates. Other fuel cell components that have a graphite substrate and a PTFE layer 34 do not include a land for receiving the PTFE layer 34.

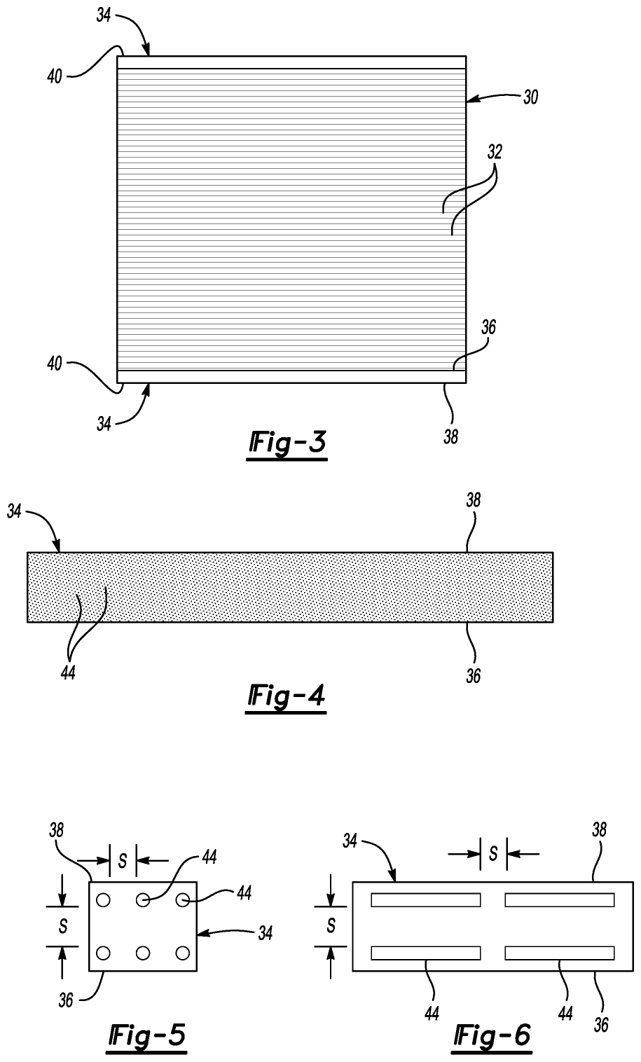

FIG. 3 shows a side of an example flow field plate 30 that includes the flow field channels 32. PTFE layers 34 are situated against portions of the illustrated side of the graphite substrate. The PTFE layers 34 are situated along opposite edges of the flow field plate 30 and parallel to the direction of the flow field channels 32.

FIG. 4 schematically shows an example PTFE layer 34. The side of the PTFE layer 34 that is received against the graphite substrate is illustrated. A plurality of segments 44 of acrylic adhesive are situated on the PTFE layer 34. The acrylic adhesive secures the PTFE layer 34 to the graphite substrate of the flow field plate 30 sufficiently for handling the component during fuel cell manufacture or assembly. For example, the acrylic adhesive secures the PTFE layer 34 to the graphite substrate sufficiently for PTFE layer 34 to remain in place when suction or a vacuum is applied to the PTFE layer 34 to lift it and the graphite substrate.

In an example embodiment, the segments 44 of the acrylic adhesive are applied to the PTFE layer 34 by a supplier of the PTFE layer 34. In other embodiments, the segments 44 of acrylic adhesive are applied to the PTFE layer 34 by a user of the material, such as a fuel cell manufacturer. With the acrylic adhesive applied to the PTFE layer 34, pressing the side shown in FIG. 4 against a selected portion of the graphite substrate is sufficient to secure the two together.

One configuration of the segments 44 of acrylic adhesive is shown in FIG. 5. In this example, the segments 44 are round or circular. Another configuration of the segments 44 is shown in FIG. 6. In that embodiment, the segments 44 are at least partially linear. Segments 44 such as dots or stripes minimize the amount of acrylic adhesive that is situated between the PTFE layer 34 and the graphite substrate of the flow field plate 30. A sufficient amount of acrylic adhesive is included to adequately adhere the PTFE layer 34 to the graphite substrate as described above.

When exposed to a liquid electrolyte, such as phosphoric acid, an acrylic adhesive tends to foam. A layer of foamed acrylic adhesive extending between the edges of the PTFE layer 34 can provide a pathway for the liquid electrolyte to migrate between the graphite substrate and the PTFE layer 34 and leak out the edge of the cell Minimizing the amount of acrylic adhesive reduces or eliminates foaming of the acrylic adhesive.

Spacing s between the segments 44 is sufficiently large to prevent the acrylic adhesive from establishing a continuous adhesive path along the interface between the PTFE layer 34 and the graphite substrate of the flow field plate 30, even if the acrylic adhesive were to foam when exposed to the liquid electrolyte of the corresponding fuel cell. The spacing s between the segments 44 of acrylic adhesive prevents the acrylic adhesive from establishing a continuous pathway between the edges 36 and 38 of the PTFE layer 34 to avoid the acrylic adhesive contributing to loss of electrolyte.

In embodiments where the PTFE layer 34 extends beyond the edge 40 of the graphite substrate, the spacing s prevents the acrylic adhesive from establishing a continuous path for acid migration between the first edge 36 of the PTFE layer 34 and the edge 40 of the graphite substrate. The portion of the PTFE layer 34 that extends between the edge 40 of the graphite substrate and the second edge 38 of the PTFE layer does not include any segments 44 of the acrylic adhesive in some embodiments.

Some embodiments include a layer of a fluoroelastomer, such as FLUOROLAST®, on the portion of the graphite substrate of the flow field plate 30. The fluoroelastomer provides a barrier to minimize any liquid electrolyte (e.g., acid) migration. The presence of fluoroelastomer and the spacing s between the segments 44 of the acrylic adhesive minimizes or eliminates any possibility for acid migration between the PTFE layer 34 and the graphite substrate.

The flow field plates 30 are example fuel cell components that include a PTFE layer 30 adhesively secured to a graphite substrate by segments 44 of acrylic adhesive. Segments 44 of acrylic adhesive secure a PTFE layer 34 to graphite substrate of a different type of fuel cell component in some embodiments.

The method or process of making a fuel cell component like the illustrated examples is efficient and cost-effective. The method includes situating the PTFE layer 34 adjacent a portion of the graphite substrate with the plurality of segments 44 of acrylic adhesive, which are spaced apart from each other, between the portion of the graphite substrate and the PTFE layer 34. Pressing the PTFE layer 34 against the portion of the graphite substrate secures the PTFE layer 34 in place.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A fuel cell component, comprising:
a graphite substrate;
a polytetrafluoroethylene (PTFE) layer adjacent a portion of the graphite substrate; and
a plurality of segments of acrylic adhesive between the portion of the graphite substrate and the PTFE layer, the acrylic adhesive securing the PTFE layer to the portion of the graphite substrate, wherein there is spacing between adjacent ones of the segments.

2. The fuel cell component of claim 1, wherein
a first edge of the PTFE layer faces toward an adjacent surface on the graphite substrate,
a second edge of the PTFE layer faces in an opposite direction than the first edge,
an edge of the graphite substrate is spaced from the first edge of the PTFE layer, and
the spacing between adjacent ones of the segments prevents the acrylic adhesive from establishing a continuous electrolyte migration path between the first edge of the PTFE layer and the edge of the graphite substrate.

3. The fuel cell component of claim 1, wherein the edge of the graphite substrate is adjacent the second edge of the PTFE layer and the spacing between adjacent ones of the segments prevents the acrylic adhesive from establishing a continuous electrolyte migration path between the first edge of the PTFE layer and the second edge of the PTFE layer.

4. The fuel cell component of claim 1, wherein the plurality of segments are arranged in a repeating pattern.

5. The fuel cell component of claim 1, wherein the plurality of segments are at least partially linear or at least partially round.

6. The fuel cell component of claim 1, wherein the plurality of segments are arranged on the PTFE layer.

7. The fuel cell component of claim 1, wherein the component is a flow field plate.

8. The fuel cell component of claim 7, wherein
the graphite substrate includes a plurality of flow channels configured to direct flow in at least one primary direction, and
the portion of the graphite substrate comprises a land along an edge of the graphite substrate that is parallel to the at least one primary direction.

9. The fuel cell component of claim 1, wherein
the portion of the graphite substrate includes at least one edge of the graphite substrate, and
the PTFE layer includes a portion that extends beyond the at least one edge.

10. The fuel cell component of claim 1, comprising a layer of a fluoroelastomer between the portion of the graphite substrate and the PTFE layer.

11. A method of making a fuel cell component, the method comprising:
situating a polytetrafluoroethylene (PTFE) layer adjacent a portion of a graphite substrate with a plurality of segments of acrylic adhesive between the portion of the graphite substrate and the PTFE layer, wherein there is spacing between adjacent ones of the segments; and
securing the PTFE layer to the portion of the graphite substrate using the plurality of segments of acrylic adhesive.

12. The method of claim 11, wherein
a first edge of the PTFE layer faces toward an adjacent surface on the graphite substrate,
a second edge of the PTFE layer faces in an opposite direction than the first edge,
the second edge of the PTFE layer is adjacent an edge of the graphite substrate, and
the method includes establishing the spacing between adjacent ones of the segments to prevent the acrylic adhesive from establishing a continuous electrolyte migration path between the first edge of the PTFE layer and the second edge of the PTFE layer.

13. The method of claim 11, wherein the plurality of segments are arranged in a repeating pattern.

14. The method of claim 11, wherein the plurality of segments are round.

15. The method of claim 11, wherein the plurality of segments are at least partially linear.

16. The method of claim 11, comprising applying the plurality of segments to the PTFE layer.

17. The method of claim 11, wherein
the fuel cell component is a flow field plate,
the graphite substrate includes a plurality of flow channels configured to direct flow in at least one primary direction, and
the portion of the graphite substrate comprises a land along an edge of the graphite substrate that is parallel to the at least one primary direction.

18. The method of claim 11, wherein
the portion of the graphite substrate includes at least one edge of the graphite substrate, and
the PTFE layer includes a portion that extends beyond the at least one edge.

19. The method of claim 11, comprising applying a fluoroelastomer to the portion of the graphite substrate prior to situating the PTFE layer adjacent the portion.
